(19) United States
(12) Patent Application Publication
(10) Pub. No.: US 2019/0018119 A1
(43) Pub. Date: Jan. 17, 2019

(54) EARLY-LATE PULSE COUNTING FOR LIGHT EMITTING DEPTH SENSORS

(71) Applicant: Apple Inc., Cupertino, CA (US)

(72) Inventors: Moshe Laifenfeld, Haifa (IL); Cristiano L. Niclass, San Jose, CA (US); Shingo Mandai, Mountain View, CA (US); Tal Kaitz, Kiryat Ono (IL)

(21) Appl. No.: 16/034,250

(22) Filed: Jul. 12, 2018

Related U.S. Application Data
(60) Provisional application No. 62/532,291, filed on Jul. 13, 2017.

(51) Int. Cl. G01S 7/486; G01S 17/10; G01S 7/481

(52) U.S. Cl. CPC G01S 7/4865; G01S 7/4817; G01S 17/10

(57) ABSTRACT

Disclosed herein are methods and devices for light emitting depth sensors such as scanning depth sensors and LIDARS. Methods, devices and systems disclose tracking a beam of reflected light pulses on an array of light sensing pixels. The tracking can dynamically update a location of the beam or an expected on-center time of the reflected light pulses at a pixel of the array. Counts of detected reflected pulses in time periods before and after the expected on-center time at a pixel are used to detect offsets in initial estimates of the beam location or timing.

### CROSS-REFERENCE TO RELATED APPLICATION

This application is a non-provisional patent application of and claims the benefit to U.S. Provisional Patent Application No. 62/532,291, filed Jul. 13, 2017, and titled “Early-Late Pulse Counting for Scanning Depth Sensors,” the disclosure of which is hereby incorporated herein by reference in its entirety.

### FIELD

The present disclosure generally relates to light detectors and light emitting depth sensors that include an array of light sensing pixels, such as pixels with single photon avalanche diodes. Such light emitting depth sensors can be used in electronic devices; examples include particular types of detection and ranging systems.

### BACKGROUND

Various devices, including personal electronic devices such as cell phones, tablet computers, and personal digital assistants, can employ object sensing and range detection systems. These and other devices create a need for real-time, three-dimensional (3D) imaging methods, devices, and systems, which are commonly known as light detection and ranging (LIDAR) systems.

In some LIDAR systems, range to an object is detected by measuring a time of flight (TOF) between emission of a pulse of light, i.e., a space and time limited electromagnetic wave, from the system and a subsequent detection of a reflection of the pulse of light from the object. The reflected light pulse can be received on an array of light sensing pixels, such as pixels that have single-photon avalanche diodes (SPADs). The TOF of the detected reflected light pulse may be measured to infer the distance to the object. Repeating the process and changing the source or direction of the emitted pulses of light allows for determining distances of various objects in a scene or field of view. The accuracy of the determined distances to objects may be related to the intensity of the reflected light pulses, the accuracy with which the reflected pulses' positions are located on the array, and so on.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Disclosed herein are methods and devices directed to the class of light detection and ranging systems that use light emitting depth sensors and systems for object detection and range (or distance) determinations. Such systems can include light detection and ranging (LIDAR) systems that use measurements of times of flight (TOF) between light pulses emitted from a device and reception of reflections of the emitted light pulses from an object or objects in a field of view (FOV). The reflected light pulses can be focused onto an array of light sensing pixels. In some cases the light sensing pixels include single photon avalanche diodes (SPADs) that detect small amounts of reflected light, including even single photons.

Some embodiments described herein involve methods of operating a light emitting depth sensor to emit a sequence of light pulses into a field of view and receive reflections of the light pulses from an object or objects in the FOV. The sequence of emitted light pulses occurs over a sequence of pulse repetition intervals (PRIs), with one light pulse emitted in each PRI. The reflected light pulses may impinge on an array of light sensing pixels and be detected by the light sensing pixels. Some aspects of the methods relate to measuring multiple TOFs over multiple PRIs at one light sensing pixel to estimate a distance to one part of the object in the FOV. The light emitting depth sensor can measure the times of flight (TOF) of the multiple received reflected pulses to statistically estimate a distance to a portion of the object. In some embodiments, a histogram of the measure multiple TOFs may be formed to detect a most likely time of flight from which the distance to the portion of the object can be estimated.

In another aspect of the methods, in some embodiments the emitted sequence of light pulses scan or sweep across the FOV, and the corresponding reflected light pulses sweep or are directed across the array. In additional and/or alternative embodiments the emitted light pulses may be emitted in fixed directions into the FOV.

In yet another aspect of the methods, the emission of the emitted light pulses may be adjusted to coordinate or synchronize the arrival time of the reflected light pulses during a time at which particular light sensing pixels have been activated. In some embodiments, determining whether an adjustment is useful or needed can be as follows.

At a particular light sensing pixel (or just ‘pixel’), a first number of detections of light pulses, that may be either background or reflected light pulses, may be counted during a first time period (in some embodiments termed the Early time period) preceding an expected on-center or other arrival time of the reflected light pulses at that particular pixel. As defined herein, an on-center time is a time at or near a center or midpoints of the particular light sensing pixel's activated period. During the particular pixel's activated period, the pixel may be activated to detect light pulses during each of a plurality (thousands, in some embodiments) of pulse repetition intervals. In some embodiments, the on-center time may be configured so that the reflected light pulses are received at the pixel with highest intensity. Doing so can produce a histogram with a stronger indication of a TOF value. Thereafter, a second number of detections of light pulses, that may be either background or further reflected light pulses, may be counted during a second time interval (in some embodiments known as the Late time period) that follows the expected on-center or other arrival time of the reflected light pulses at the particular pixel. Adjustments may then be made to operation of the light emitting depth sensor based on the first number and the second number, such as by finding the difference.

In additional and/or alternative embodiments the first time period and the second time period may each span a respective number of pulse repetition intervals; i.e., each of the Early and Late time periods may span a multiple of the time intervals between emitted pulses. A reflected pulse that is received in time proximity closer to the expected on-center time can be weighted more when determining the TOF. Adjustments that can be made to the operation of the light emitting depth sensor include altering the expected on-center time of the reflected pulses at the pixel, adjusting the duration of the first time period and/or the duration of the second time period, adjusting directions of the emitted light pulses, adjusting how the reflected light pulses are focused on the array, adjusting which pixels are associated with certain scene locations, among others.

The present disclosure also describes an electronic device having a light emitter, an array of light sensing pixels, and an electronic timing control system. The electronic timing control system can be configured to provide a first set of timing signals that cause the light emitter to emit a sequence of light pulses into a field of view, and to provide an activation signal to activate a light sensing pixel of the array to detect reflected light pulses corresponding to reflections of the emitted light pulses from an object in the field of view. The electronic device may also have a Time-to-Digital Converter (TDC) to obtain a TOF of the detected reflected light pulses.

In some embodiments, the electronic timing control system can also be configured to obtain a count of a first number of the detected light pulses, that can include both background and reflected light pulses, during a first time period preceding an expected on-center or other arrival time of the reflected light pulses at the pixel. The electronic timing control system can also be configured to obtain a count of a second number of the detected light pulses, that can include background and reflected light pulses, during a second time period following the expected on-center or other arrival time of the reflected light pulses at the pixel. The first number and the second number can be obtained by a counter, such as an Up-Down Counter, that can be a component of the electronic timing control system or a separate component. The electronic timing control system can also be configured to adjust operation the electronic device based on a difference between the first number and the second number.

Additional and/or alternative embodiments may include any of the following features, elements, or operations. The electronic device can use a line scan pattern for the emitted sequence of light pulses. The electronic device can use a feedback loop using at least the difference between the first and second numbers to apply a correction to the expected on-center time, or to the first or second time periods. The light sensing pixels of the array can include single photon avalanche diodes (SPADs).

The present disclosure also describes another method of operating a light emitting depth sensor that includes an array of light sensing pixels. Operations of the method include emitting light pulses into a field of view, and receiving reflected light pulses corresponding to the emitted light pulses from an object in the field of view. The method can include counting respective numbers of the reflected light pulses that are received on a subarray of the light sensing pixels of the array during a counting time period, and adjusting operation of the light emitting depth sensor based on differences among the respective numbers. The adjustments include changing how the reflected light pulses are directed onto the array of light sensing pixels, adjusting the emission of the light pulses into the field of view, modifying an expected on-center or other arrival time of the reflected light pulses at a location of the array.

### BRIEF DESCRIPTION OF THE DRAWINGS

The disclosure will be readily understood by the following detailed description in conjunction with the accompanying drawings, wherein like reference numerals designate like structural elements.

FIG. 1 shows a block diagram of a general detection and ranging system, according to an embodiment.

FIG. 2 shows an expanded view of a light emitter and light sensing pixel in a detection and ranging system, according to an embodiment.

FIG. 3 shows a graph of multiple emitted light pulses and corresponding histogram of measurements of times of flight of multiple reflected pulses detected by a light sensing pixel, according to an embodiment.

FIG. 4 shows components and operations of a line scan operation of a light detection and ranging (LIDAR) system that uses a light emitting depth sensor and scanning of a field of view, according to an embodiment.

FIG. 5A shows an array of light sensing pixels as used in a scanning light emitting depth sensor, according to an embodiment.

FIG. 5B shows shifting of intensities of multiple reflected light pulses across a row of pixels in an array of light sensing pixels during a line scan operation, according to an embodiment.

FIG. 5C shows a graph of intensities of arriving reflected light pulses at one pixel, according to an embodiment.

FIG. 5D shows a graph of light pulse intensities of arriving reflected light pulses at one light sensing pixel in an array of light sensing pixels versus the pulse repetition interval (PRI), according to an embodiment.

FIG. 6 shows an array of light sensing pixels and block diagrams of associated circuitry, according to an embodiment.

FIG. 7 shows a timing diagram for a scan of an array of light sensing pixels, according to an embodiment.

FIG. 8 shows a graph of intensities of arriving reflected light pulses versus PRI number subdivided into an Early subset and a Late subset, according to an embodiment.

FIG. 9 shows a timing diagram of detected light pulses versus time, and a corresponding sweep of reflected light pulses' intensities across pixels in an array of light sensing pixels, according to an embodiment.

FIG. 10 shows a graph of difference in counts of Early and Late reflected light pulses against offset of beam location from the predicted on-center or other arrival time at a light sensing pixel, according to an embodiment.

FIG. 11 shows a feedback loop for updating predicted beam location, according to an embodiment.

FIG. 12 shows a flow chart for a method of operating a light-based range detection system, according to an embodiment.

FIG. 13 shows a block schematic of circuitry for obtaining histogram and Early-Late data from multiple pixels, according to an embodiment.

FIG. 14 shows two cases of using a pixel array to determine beam location, according to an embodiment.

FIG. 15 shows a flow chart of a method for operating a light-based range detection system, according to an embodiment.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following disclosure is not intended to limit the embodiments to one preferred embodiment. To the contrary, it is intended to cover alternatives, modifications, and equivalents as can be included within the spirit and scope of the described embodiments as defined by the appended claims.

The embodiments described herein are directed to light emitting depth sensors that detect objects in a field of view and determine the ranges or distances to them. The light emitting depth sensors operate by emitting light pulses, such as laser light pulses, into the field of view and determining the times until the reflected pulses are received on a light detector. The light detector can use an array of light sensing pixels to detect the reflected light pulses. A first type of light emitting depth sensor uses a limited number of light emitters, in some embodiments just one, that scan or sweep across the field of view by varying the directions of emission of the light pulses. A second type of light emitting depth sensor uses multiple light emitters that emit their respective light pulses in different fixed directions.

The first type of light emitting depth sensor can scan a portion of the field of view by line scans (e.g., horizontal or vertical line scans) across the field of view. The reflected light pulses can then be concentrated or focused in a beam of reflected light pulses that moves correspondingly across the array. The light sensing pixels in the array located where the beam of reflected light pulses impinges on the array can then be monitored for detection of light pulses. The detected light pulses may be either background (i.e., noise) light pulses or reflected light pulses. The pixels can be monitored in coordination with the emission of the light pulses and/or an expected arrival time or location of the beam of reflected light pulses at the pixels. By synchronizing the activation of certain of the light sensing pixels with the expected arrival time or location of the reflected light pulses, not all of the light sensing pixels in the array need be activated at once, power consumption can be reduced, interference between pixel circuitry can be limited, and other advantages may be obtained. Accuracy of the distance determination may be enhanced by careful synchronization and/or coordination of when or where the reflected light pulses impinge on the array and when/which pixels are monitored.

Other types of light emitting depth sensors use multiple light emitters, such as laser pulse emitters. Each of the light emitters may direct a sequence of emitted light pulses into the field of view in a fixed direction. Detection of reflections of the emitted light pulses can then be performed as described above to detect a part of an object in the field of view along that fixed direction.

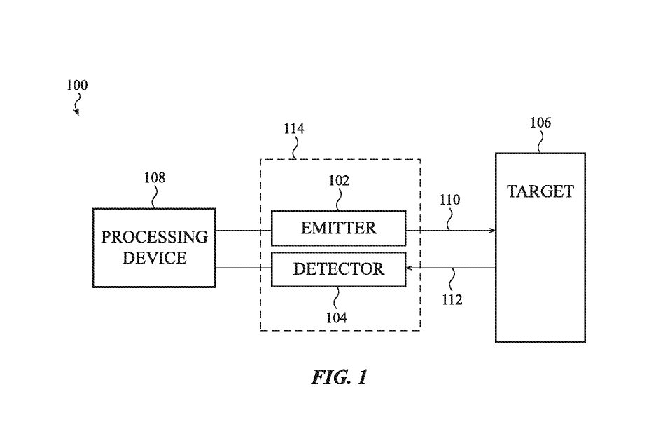

These and other embodiments are discussed below with reference to FIGS. 1-15. However, those skilled in the art will readily appreciate that the detailed description given herein with respect to these Figures is for explanatory purposes only and should not be construed as limiting.

FIG. 1 illustrates a block diagram of one example of a general detection and ranging system 100. The detection and ranging system 100 includes a light emitter 102, a light detector 104 (hereinafter just “detector”) that may include an array of light sensing pixels, and a processing device 108. The light emitter 102 and the light detector 104 may each represent one or more light emitters and detectors, respectively. The light emitter 102 and the detector 104 may be part of a single emitter/detector unit 114 (e.g., contained on a single integrated circuit (IC), a System-on-Chip (SOC), etc.), as indicated by the dashed line, or may be separate units in the system. The light emitter 102 is positioned to emit light towards an object (or “target”) 106, and the detector 104 is situated to detect light reflected from the object 106.

The processing device 108 is operably connected to the light emitter 102 and to the detector 104. The processing device 108 may be part of the single emitter/detector unit 114, or may be a separate unit or set of units. The single emitter/detector unit 114 may include an electronic timing control system, which may coordinate timing of emission of the light and reception of the reflected light.

The processing device 108 may cause the light emitter 102 to emit light towards the object 106 (emitted light represented by arrow 110). The light reflected from the object 106 and/or the scene may then be detected by the detector 104 (reflected light represented by arrow 112). The processing device 108 receives the output signals from the detector 104 and processes the output signals to determine one or more characteristics associated with the reflected light, the object 106, and/or the scene. The processing device 108 may obtain estimates of the presence and range (distance) to the object 106 using the one or more characteristics of the emitted and reflected light.

Alternatively, the system 100 may be part of an electronic device in which the illumination of the FOV is not scanned but rather is illuminated in fixed directions, such as by multiple emitters. In such systems (e.g., fixed pattern systems), one or more of multiple light pulses may be emitted (e.g., multiple contemporaneously light pulses may be emitted), and each emitted light pulse may be directed or disbursed in selected directions. For example, in a facial recognition system multiple directions may be selected for a first set of simultaneous emissions. The various reflected pulses may then be used to detect distinguishing facial features of a user. For a second set of emitted light pulses, the directions may be reselected and varied.

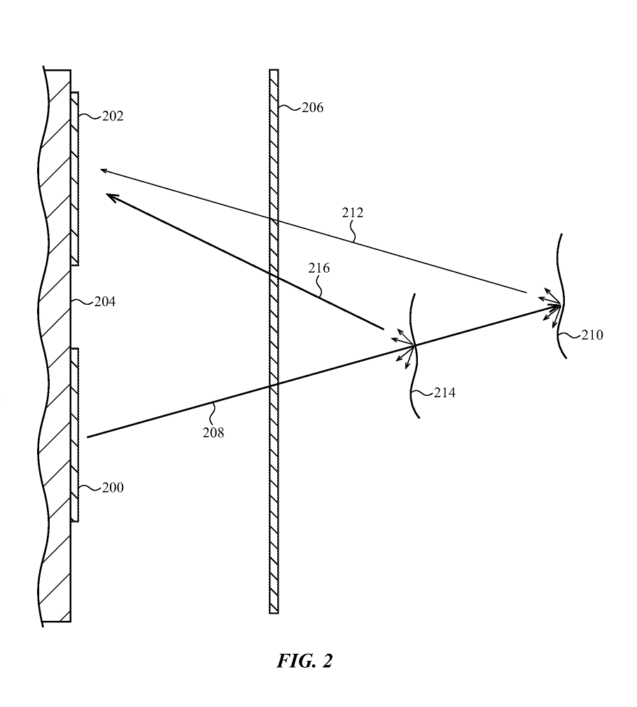

FIG. 2 depicts a simplified view of components of a system having a light emitter 200 (or just “emitter”) and a light detector 202 (or just “detector”), such as may be found in a light emitting depth sensor. In the illustrated embodiment, the emitter 200 and the detector 202 are disposed on a common substrate or support structure 204, although this is not required. In other embodiments, the emitter 200 and the detector 202 may be positioned on separate substrates. A transparent or translucent cover layer 206 may be positioned over the emitter 200 and the detector 202. The cover layer 206 may be a color filter that may filter most wavelengths other than the wavelength at or near the wavelength of a laser light emitted by the emitter 200.

In embodiments of such systems in which the detector 202 has pixels that include SPADs to detect light, a SPAD may be activated by being placed into a reversed biased state, such as by accompanying transistors or other circuitry. In particular, a SPAD is operated in the avalanche region of reverse bias. When one or more photons enter the SPAD, charge carriers are created that migrate to an electrode. In so doing, they cause a cascade or “avalanche” that increases the number of charge carriers leading to a measurable current spike. Surrounding circuitry, also called an analog front end, can amplify the current spike and transmit a signal indicating the reception of the photon(s). To save energy and prevent or reduce false positive reception signals, the diode can be de-activated (e.g., biased away from a reverse breakdown region) when its light detection operations are either not expected or not desired.

While the detector 202 may use SPAD technology, the embodiments disclosed herein may use other light sensing pixel technologies, such as NMOS, PMOS, or CMOS light sensing pixels. For simplicity of discussion, the detector 202 will hereinafter be described as a SPAD pixel.

The emitter 200 may be a laser or other suitable light source that emits light 208 towards an object or FOV over a given period of time. In some embodiments, such as those using a line-scan system, the emitter 200 repeatedly emits a light pulse over a FOV detection period. The waveform of a transmitted light pulse may be a substantially symmetric bell curve shape (e.g., a Gaussian shape), although other distributions, such as a Poisson distribution, are also possible. An emitted light pulse typically is a space and time limited electromagnetic wave, and its intensity may be specified by, for example, the magnitude of its Poynting vector. A laser pulse may be considered as comprising multiple photons of a single frequency.

When an object 210 or 214 is in the field of view, the emitted light pulses ideally may be reflected from the object and the respective reflected light pulses 212 and 216 may impinge on the detector 202. However, under real world conditions, some or all of the emitted light pulses or photons may be reflected away from the detector altogether, may be absorbed by the object or the atmosphere, or may be otherwise prevented from returning to the detector. The waveform of the reflected light pulses 212 and 216 may be an attenuation or distortion of the waveform of the emitted light pulses, and may be reduced in intensity, but may still be a space and time limited electromagnetic wave pulse and may be include multiple photons.

Under ideal reflection and reception conditions, the detector 202 would detect one reflected light pulse for each emitted light pulse. A time of flight (TOF) between emission of the emitted light pulse and detection of the reflected light pulse can be used to determine the distances to objects 210 and 214, using distance=TOF*c/2, where c is the speed of light. The distance to object 210 (or object 214) is typically much larger than the separation distance between the emitter 200 and the detector 202, so the latter distance is negligible for this calculation.

However, in practice the ideal is not always the case. Not only may the reflected light pulse be reflected away from the detector, the emitted light pulse may be absorbed entirely by the object. Further, the reflected light pulse may be so reduced in intensity that it fails to trigger detection by any light sensing pixel of the detector. The intensity of a reflected light pulse impinging on a light sensing pixel may correspond to the number of photons in a reflected light pulse impinging on the light sensing pixel. The waveform of the reflected light pulse may represent a probability of detection of that reflected light pulse by the light sensing pixel. Further, the detector 202 may be triggered by pulses of ambient background light. Consequently, a statistical approach using detections of multiple light pulses at a light sensing pixel may be used to improve object detection and distance determination, as will now be described.

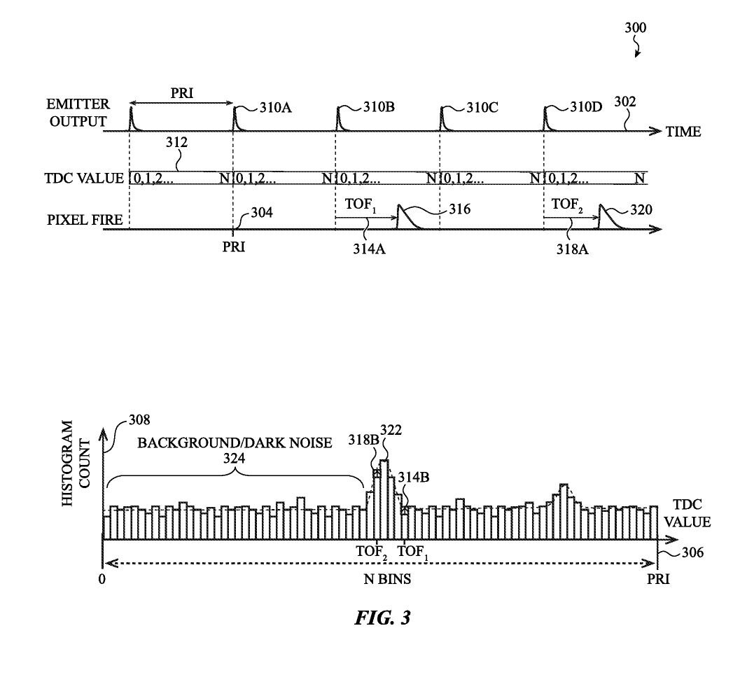

FIG. 3 shows how a sequence of emitted light pulses can be used to detect and range (i.e., determine a distance to) an object in a FOV by a light emitting depth sensor. Accuracy of the determination of objects' ranges can be improved, and false detections rejected, if the objects are detected and ranged on the basis of multiple detections of reflected light pulses from the sequence of emitted light pulses. The following explains one method distance calculation based on the statistics of multiple measurements or estimates of times of flight. Variations within the scope of this disclosure will be recognized by one skilled in the art.

The top line of the top graph 300 of FIG. 3 shows an emitter's output comprising emitted light pulses 310A-310D along a time axis 302. The light pulses are separated by an interval of time termed a pulse repetition interval (PRI) 304. Within each PRI 304 the emitted light pulse typically occurs for a small portion of the PRI 304. In some embodiments the PRIs have values on the order of 30 ns to 40 ns, though this is not required. Thus, for an object in the FOV at a distance of 1 meter, the TOF will be approximately 6 ns. The PRI 304 for a particular application can be selected so that the TOF to and from an object at a maximum desired detection distance will be less than the PRI 304 and so allow for correlation of each emitted light pulse with each detection of a reflected light pulse.

The second line of the top graph of FIG. 3 shows that within each PRI 304 a counting process can be implemented by a Time-to-Digital Converter (TDC). The TDC operates as a discrete time clock that cyclically counts a number of discrete time intervals 312 from the start of each PRI 304. The TDC can be included as part of the electronic timing control system, or can be a separate component operably linked with the electronic timing control system. The TDC can be synchronized to start each cyclical count with the start of each PRI. In some embodiments each PRI 304 is divided into discrete time subintervals of equal duration. In other embodiments the time durations of the discrete time subintervals need not be equal. In the embodiment shown, in which each PRI is subdivided into N subintervals of time, the duration of each subinterval of time would be the duration of the PRI divided by N.

The third line of the top graph in FIG. 3 shows detection of reflected light pulses by a single SPAD pixel as a function of time. In the example depicted, during the first and second PRIs, there is no detection of the corresponding reflected light pulses. This may occur due to absorption of the reflected light pulse by the air or the cover layer 206, misdirection of the reflected light pulse, insufficient avalanche triggering in the SPAD pixel, error in its associated analogy front end circuitry, or other sources.

During the third PRI, a reflected light pulse 316 is detected. Because the object is within a maximum detection distance, the reflected light pulse 316 is a reflection of the emitted light pulse 310B. The TOF₁ 314A is obtained by the TDC, as explained below. During the fifth shown PRI, another reflected light pulse 320 is detected, which is a reflection of emitted pulse 310D and which has a respective TOF2 318A.

The bottom plot in FIG. 3 shows a histogram giving the counts of measurements of times of flights of reflected light pulses detected over the sequence of multiple PRIs. The horizontal axis 306 shows the duration of a single PRI subdivided into the N successive discrete time intervals 312, each of duration PRI/N. The vertical axis 308 is the number of counts held in a block of N memory locations (or “bins”), each bin corresponding to a respective one of the discrete time intervals 312. The TDC can comprise a timer and circuitry to rapidly address and increment a counter for the bin corresponding to the particular discrete time subinterval during which a light pulse is detected by the SPAD pixel. In the example shown, during the third PRI, when the reflected light pulse 316 is detected, the TDC measures the TOF₁ 314A and increments the corresponding count 314B in the respective bin in the histogram. During the fifth PRI, when the reflected light pulse 320 is detected, the TDC measures the TOF₂ 318A and increments the corresponding count 318B in the respective bin in the histogram.

Over a large number of PRIs, a number of light pulses may be detected that are not reflections of the emitted light pulses, but instead arise from background light or other false avalanche triggering of the SPAD pixel. Even detections of actual reflections of emitted light pulses may show statistical variation. This is indicated by the TOF₁ 314A being counted in the bin 314B, and the second TOF₂ 318A being counted in the bin 318B. However, over the large number of PRIs, the statistical variation of the TOFs of the actual reflections of emitted light pulses may cancel and may produce a peak 322 in the histogram. The peak 322 may be above the background noise level 324 of detected light pulses not arising as reflections of emitted light pulses. The discrete time subinterval corresponding to the peak 322 can then be taken as the TOF and used to obtain the range to the object.

The operations discussed in relation to FIGS. 2-3 pertain to a single emitter and a single light sensing pixel. However, as previously mentioned, in systems that use scanning, the emitted light pulses are emitted into and in some embodiments swept or scanned over a portion of the FOV. The reflected light pulses then will not always be received by a single light sensing pixel. As will now be explained, the operations described in relation to FIGS. 2-3 can be adapted for detection and ranging using an array of light sensing pixels, such as an array of SPAD pixels.

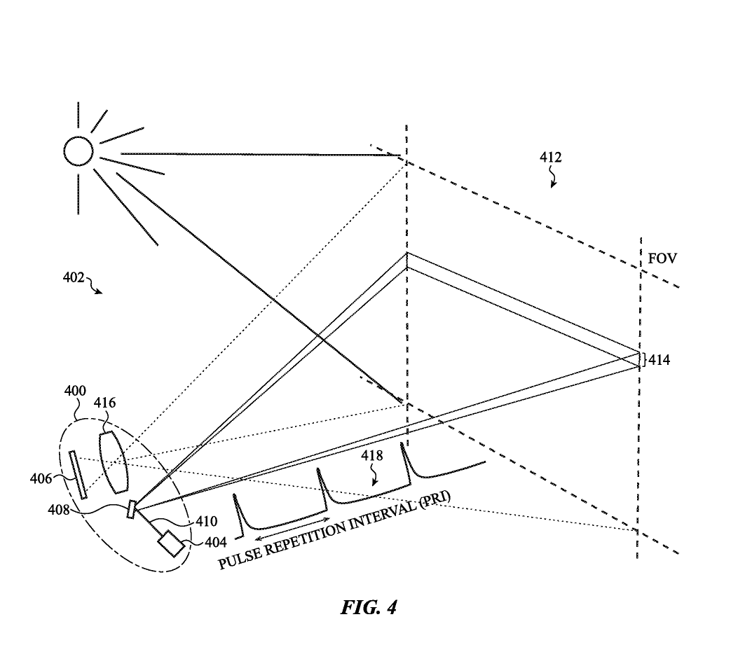

FIG. 4 illustrates components and operations of the scanning type of detection and ranging systems that uses a light emitting depth sensor 400. The light emitting depth sensor 400 has an array 406 of light sensing pixels (or just “array” and “pixels”) that may use single photon avalanche diodes (SPADs). In other embodiments, the array 406 may use light sensing pixels based on other technologies.

The particular example illustrated uses a line scan operation 402 for detecting presence of an object and determining a range to the object. The system performing the line scan operation 402 includes a light emitting depth sensor 400. The light emitting depth sensor 400 includes a light emitter 404 and an array 406 (e.g., an array of pixels based on SPADs). The light emitter 404 repeatedly emits a sequence of light pulses 418 separated by time periods during which no light is emitted. The time period between each light pulse may be referred to as a pulse repetition interval (PRI).

Collectively, the sequence of light pulses 418 are referred to herein as an emitted light beam 410. The emitted light beam 410 is steered or directed towards a field of view (FOV) 412 (or a portion thereof) so that only a section 414 (e.g., a line) of the FOV 412 is illuminated at a time. The desired portion of the FOV 412 is scanned section-by-section during a FOV detection period. The FOV detection period is the time period needed to scan the entire desired portion of the FOV.

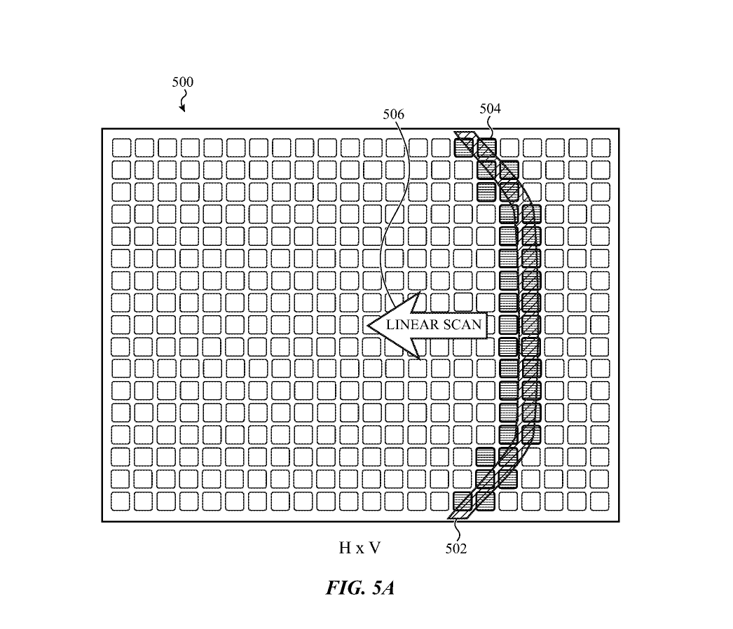

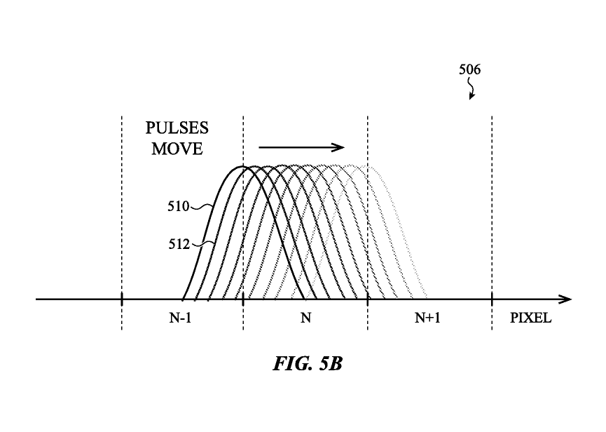

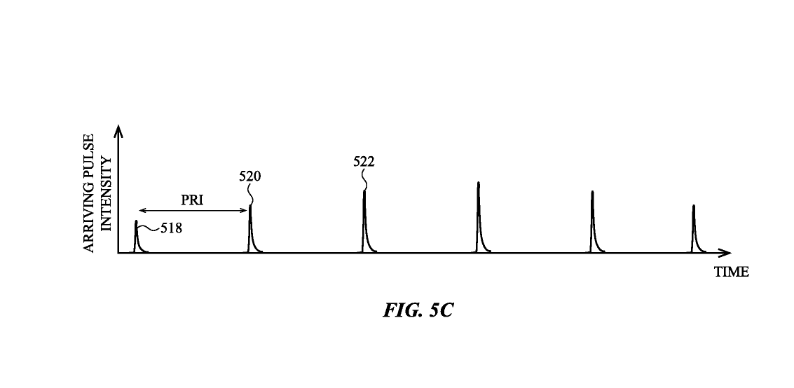

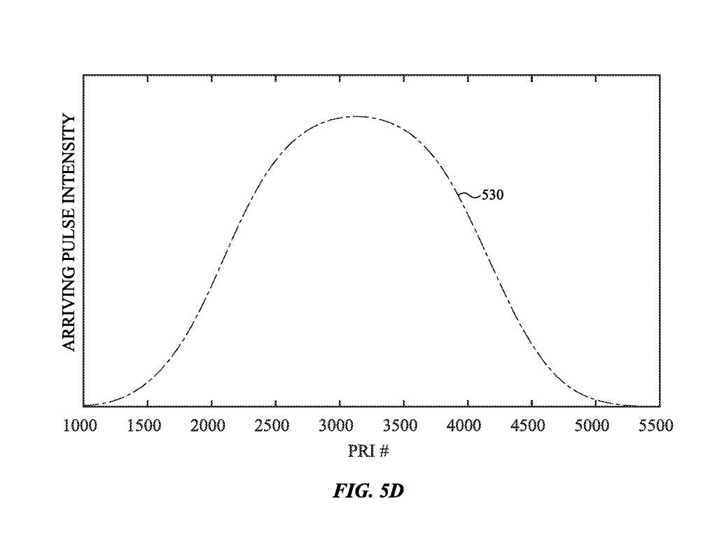

The light that reflects off an object and/or the scene in the FOV 412 can be received by a lens 416 that directs the light onto the array 406. The array 406 may be configured as a rectangular array. Since the emitted light beam 410 is a sequence of light pulses 418, the reflected light may be comprised of a sequence of reflected light pulses. As will be described in more detail in relation to FIGS. 5A-D, sections of pixels in the array 406 can detect the reflected light pulses through a series of line scan operations. Each line scan operation may scan or read out the pixels in a section of the pixel array (e.g., two or three pixels in one column) at a time. When the line scan operation for one section of pixels is complete, another section of pixels may be scanned. In one embodiment, the next section of pixels includes some of the pixels in the previous line scan operation. In another embodiment, the next section of pixels includes different pixels from the pixels in the previous line scan operation. This process may repeat until all of the pixels have been scanned.

In some embodiments, a beam-steering element 408 (e.g., a mirror) is positioned in the optical path of the light emitter 404 to steer the emitted light beam 410 emitted by the light emitter 404 towards the FOV 412. The beam-steering element 408 is configured to control the propagation angle and path of the emitted light beam 410 so that only a section 414 of the FOV 412 is illuminated at a time.

The emitted light beam 410 can be generated and/or steered differently in other embodiments, such as the fixed direction systems mentioned previously. For example, the light emitter 404 can include multiple emitters such that each emits light toward a different section of the FOV 412.

An electronic timing control system (not shown) can deactivate some or all of the light sensing pixels in the array during emission of each pulse of light to preclude the light sensing pixels from being saturated or giving a false signal. In some embodiments the electronic timing control system can then send a set of timing control signals to the light emitter 404 to initiate or control emission of the sequence of light pulses. The electronic timing control system may subsequently send an activation signal to one or more selected pixels in the array during times when no light is being emitted so that only the activated pixels become configured to detect reflections of the emitted light pulses.

FIG. 5A shows an exemplary array 500 comprising light sensing pixels, having H many pixels per row (with rows shown as oriented bottom to top on the page), and V many pixels per column (with columns shown oriented across the page). The individual light sensing pixels may use SPAD detectors, as described above. The array 500 may be part of a light emitting depth sensor in which the emitted light pulses are swept over the FOV, such as by the line-scan system discussed in relation to FIG. 4. An emitted sequence of light pulses can then be reflected from an object in the FOV and form a beam of reflected pulses that sweeps across the array 500.

FIG. 5A shows a subset 504, indicated by cross-hatching, of the light sensing pixels in the array 500. The subset 504 of the light sensing pixels includes those light sensing pixels on the path 502 made by the beam of reflected light pulses during one sweep of the beam across the array 500. The path 502 of the beam may not be straight due to distortions or imperfections, such as may be caused by the lens 416. In some cases the path 502 may be known, at least approximately, such as by initial calibration and synchronization of the light emitting depth sensor.

For a light emitting depth sensor sweeping an emitted beam across the FOV, the beam of reflected light pulses may stepwise move over the rows of pixels from right to left, as indicated by the arrow 506, with the beam sweeping across each row (i.e., vertically) within each step. When the traversal pattern of the beam is known, only those light sensing pixels in the anticipated location of the beam need to be activated for reception and detection of the reflected light pulses. This can allow for a reduction in power use by the array 500 but requires timing and location determination of the paths of the beam.

In some embodiments, approximate determination of the time and location of the path 502 of the beam on the array 500 can be provided by processing that occurs off the array 500. For example, when the light emitting depth sensor is used with a line-scan system as in FIG. 4, the position of the beam-steering element 408 (e.g., a mirror) and information about the lens 416 can be used to obtain an estimate for where on the array 500 the beam will strike. While such an externally provided estimate may suffice in some applications and embodiments, if a more accurate determination of a sweeping beam's arrival time at specific pixels can be determined, greater accuracy of the distance to the object may be obtained. Further, it may be that such externally provided estimates of the times and locations of the path 502 may become offset over usage of the device. This may occur due to component tolerance drift or due to disruptive outside events, such as a drop of the device.

In addition to determining more accurately the sweeping beam's arrival time at a specific pixel's location, operations of the light emitting depth sensor can be altered to correct for errors in initial estimates of the beam's locations and arrival times at successive light sensing pixels. For example, if the lens 416 has flaws or is imperfectly mounted (or has shifted during a drop event), the expected path 502 of the beam may not be as initially estimated. Compensations can then be applied.

FIG. 5B shows a series of intensities of reflected light pulses, including reflected light pulses 510 and 512, shifting positions across three successive light sensing pixels as the beam traverses a row of the array 500. In the example, it is desired to obtain TOF information using the pixel N, 506, as discussed above in regard to FIG. 4. To do so, pixel N is to be activated during the time in which reflected light pulses can be expected to land or impinge on it. The activation of pixel N should thus be synchronized with a corresponding part of the whole sequence of the emitted light pulses in the whole line scan operation.

FIG. 5C shows a graph of the received intensity of the reflected light pulses shown in FIG. 5B as they track across the pixel N. A reflected light pulse that spatially only partly impinges on pixel N, such as light pulse 510, impinges on pixel N with only a small intensity 518. As the sequence of reflected light pulses traverses pixel N, more of the light (e.g., number of arriving photons hitting a SPAD) impinges on pixel N at a greater intensity 520. When the beam impinges directly and/or centrally on pixel N, the reflected light pulses impinge on pixel N at a maximum intensity 522. Thereafter, as the beam continues to sweep across the row towards pixel N+1, the intensities received of the reflected light pulses impinging on pixel N begin to fall.

FIG. 5D shows a plot of received reflected light pulse intensities 530 received at pixel N (vertical axis) versus a counting of the PRIs of the emitted light pulses (horizontal axis). FIG. 5D indicates that coordination and/or synchronization of the PRI number with the pixel at which the respective reflected light pulses are received can produce a stronger histogram peak 322 signal for that pixel. This coordination involves knowing an expected on-center time of the reflected light pulses at the pixel, i.e., the time (such as measured according to the PRI count) at which a reflected light pulse of the beam is expected to directly impinge on the light sensing pixel to produce a maximum of received intensity. Methods and devices for obtaining such coordination will now be described.

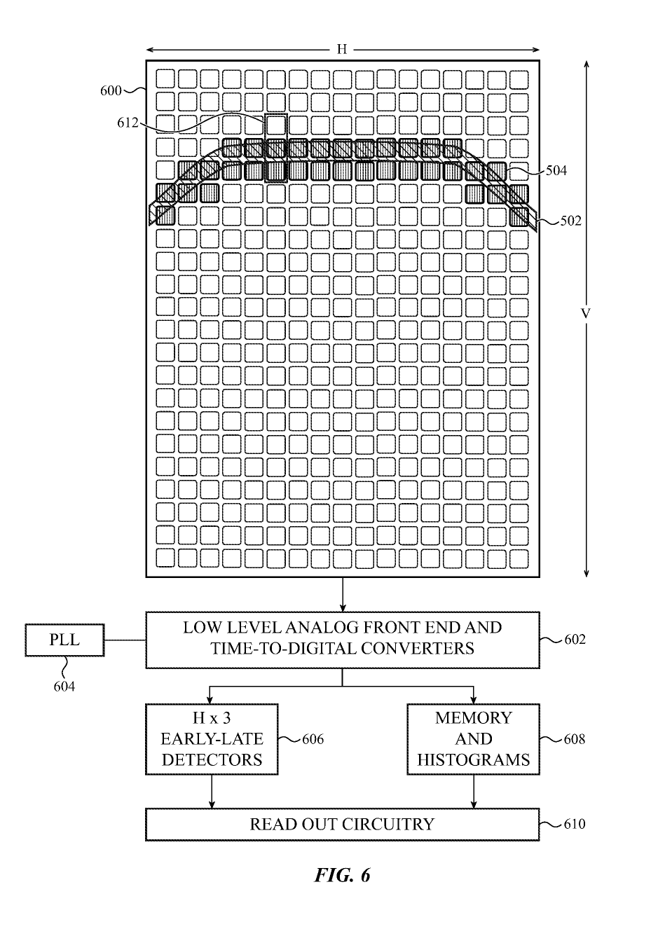

FIG. 6 shows block diagram of a specific embodiment of an array 600 of light sensing pixels with further associated circuitry. For purposes of discussion the dimensions of the array 600 are taken as H many rows by V many columns. For purposes of speed and efficiency of the operations to be described, the associated circuitry can be integrated with the array 600, though this is not a requirement.

The path 502 of the beam of reflected light pulses horizontally across the array 600 together with the subset 504 of light sensing pixels on the path are as discussed in relation to FIG. 5A. The associated processing circuitry is configured to process in parallel multiple columns of size V. In the example shown, pixels from three rows are processed in parallel. The beam may initially be expected to sweep horizontally and be expected to impinge (to some degree) concurrently across three rows. The timing of the arrival of the beam at a particular pixel discussed with respect to FIG. 5B applies to each of the three pixels 612 within a single column and three adjacent rows. This allows the Early-Late calculations discussed below to be performed concurrently on the three pixels 612 during a horizontal sweep of the beam. The average of the calculations can then be used. On a subsequent sweep of the beam across a subsequent (vertically shifted) row, the three selected pixels can be from adjacent rows that are shifted vertically with respect to the pixels 612. In some embodiments the three subsequently selected pixels may be just a shift down by one row from the pixels 612, allowing the operations to be performed on each pixel more than once. This can allow for improved range detection and/or correction of tracking of the beam. One skilled in the art will recognize that other numbers than three may be used.

Associated to array 600 is front end circuitry 602 that can detect, amplify, buffer, or perform other operations on an output of each light sensing pixel. In some embodiments, such circuitry typically includes analog components, such as amplifying or buffering transistors. The front end circuitry can include Time-to-Digital converters as described above that determine within each PRI the discrete time interval at which an output pulse is produced at a respective pixel.

The associated front end circuitry 602 can include or be linked with an electronic timing control system that may itself be linked with an external phase-locked loop 604. The electronic timing control system may provide timing information, such as start times of each PRI or starts of Early or Late time periods discussed below, corresponding to the light sensing pixels. The electronic timing control system may also provide activation signals to light sensing pixels. The activation signals provided by the electronic timing control system may configure a selected set of the pixels, such as of pixels in a row to be swept by the beam, to be able to receive reflected light pulses. For example, an activation signal may cause control transistors associated with a SPAD to bring the SPAD into its avalanche region of reverse bias.

The front end circuitry 602 may be linked with both Early-Late detector 606 and with a memory 608 that can be configured to record the histograms formed for each of the pixels in the path 502 swept by the beam. At the end of each sweep of the beam, the results are processed by read out circuitry 610. The results can be used for determination of a range to an object, and, if needed, adjustment of operations. In this example the Early-Late detectors 606 will analyze H×3 pixels during a single sweep of the beam. In other embodiments both the number of columns and rows may be different. The number of rows in the line scan operation can be the number of rows in the array 600.

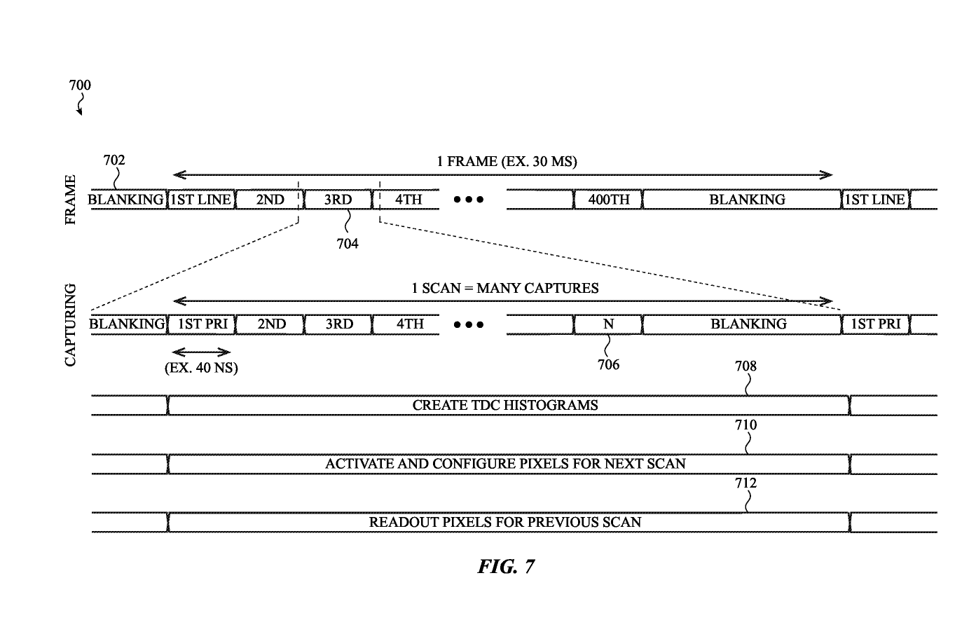

FIG. 7 shows a timing diagram 700 of a light emitting depth sensor using the array 600 during scanning of a portion of a FOV. The FOV is scanned in a first number of sections (400 sections or lines are shown in FIG. 7 as an example, although other numbers of sections may be used in different embodiments), one for each of the rows in the array 600. The scans of all sections occur within a frame having a frame time (shown in FIG. 7 as a frame time of 30 ms, though other embodiments may use different frame times). A blanking interval 702 can occur at the end of each frame for read out and other operations, such as moving the beam-steering element 408 (e.g., a mirror) for the next scan.

For measurements taken in each section, a sequence of light pulses may be emitted at a constant PRI. For the third section 704, the respective PRIs are shown in the second line of FIG. 7. In the example shown the PRIs, each of duration 40 ns, are enumerated from 1 to N, with the Nth PRI 706 followed by a blanking interval. As shown above in relation to FIG. 5B, in some embodiments, during the scan of the third section the directions of the emitted light pulses may be changed so that, in an ideal case, the reflected light pulses move across an array of pixels (ideally, one column of the array 600). In other embodiments other techniques, such as adjusting a lens in front of the array, may be used to cause the reflected light pulses to move across the array of pixels.

As indicated by the third line in FIG. 7, during the third section's scan time 708, the TDC circuits create histograms for each of the group (e.g., an H×3 subarray) of pixels being analyzed during the scan time. Also during the third scan time, other pixels are being activated (e.g., brought ready to receive light pulses) and otherwise made ready for the next scan as indicated in line 710. Also during the third scan time, the read out circuitry 610 can be transmitting the results of the previous scan, as indicated in line 712. In this way efficiency can be achieved by pipelining the operations.

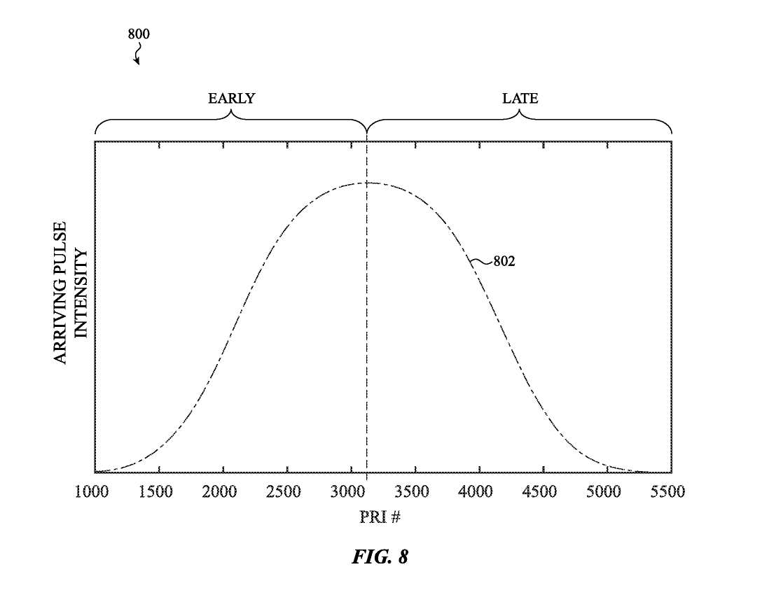

FIG. 8 shows a plot 800 of the intensities 802 of reflected light pulses impinging on a particular pixel in the third scan of FIG. 7 in an ideal case. As the beam sweeps across the pixels in a row, in this ideal configuration it is expected that the beam will land centrally and directly on the second pixel at the 3000^{th} PRI. Before that, some of the reflected pulses will be expected to impinge on the first pixel. After that, the beam's reflected light pulses shift onto the third pixel. The time of the 3000^{th} PRI is said to be an expected on-center time of the reflected light pulses at the second pixel.

So to make a histogram of TOF values of received reflected light pulses at the second pixel using the method discussed above in relation to FIG. 3, a first time period before the expected on-center time period (the Early time period) and a second time period (the Late time period) after the expected on-center time are to be selected. In the ideal case of an accurately known expected on-center time, the Early and Late time periods can be chosen equal in length about the expected on-center time. The Early and Late time periods need not cover the full width of the graph of the intensities 802, but may cover only time periods at which the intensity of the reflected pulses is expected to be above a certain level. In other embodiments, the Early and Late time periods can cover most or all of the full width of the graph of the intensities 802, but reflected light pulses having time proximities closer to the expected on-center time can be given more weight, either in the formation of the histogram or in determination of a TOF from the histogram.

In some embodiments, the methods described here based on an on-center time may be readily adapted to another arrival time, such as an off-center time or dividing time point about which a distribution of expected arrivals of reflected light pulses is known. For example, at a certain off-center time, it may be expected that 25% of the reflected light pulses will arrive before that off-center time and 75% of the reflected light pulses will arrive subsequent to that off-center time. Deviations from the expected distribution, as discussed below, may also give usable information for adjusting operation of the light emitting depth sensor.

This ideal case presumes accurate knowledge of the expected on-center time. As previously described, sources external to the array of light sensing pixels can provide initial estimates for the beam's location and/or expected on-center time, but these may not be fully accurate. Embodiments will now be described that use differences between counts of reflected light pulses received during the Early time period and the Late time period about the expected on-center time to improve the accuracy of expected on-center time. This improved accuracy can be used to increase synchronization of the beam and the activation of the light sensing pixels.

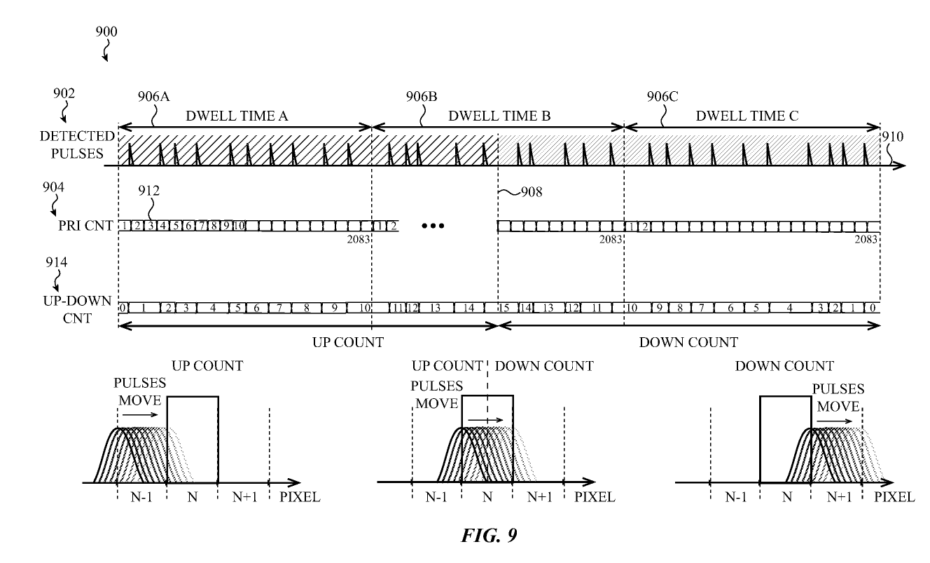

FIG. 9 shows correlated plots 900 of received reflected light pulses and counted quantities versus a time shown on the time axis 910. In FIG. 9 the bottom row of figures shows the ideal movement of the reflected light pulses across three adjacent pixels during a single sweep of the beam. Details of such movement were presented in relation to FIG. 5B.

The top graph in FIG. 9 shows an example of received pulses at pixel N, the target pixel, versus the time axis 910. An expected on-center time 908 has been initially estimated, such as from a source external to the array. The time about the expected on-center time 908 is straddled by three dwell time intervals 906A-C. Each dwell time interval covers a fixed number of PRIs; in the example shown each dwell time interval comprises 2083 PRIs. The first dwell time interval 906A covers an initial 2083 PRIs from the start of the PRI count (CNT) in line 904. The second dwell time interval 906B is divided to have a (nearly) equal number, 1041, of its PRIs both before and following the expected on-center time 908. The third dwell time 906C covers a final 2083 PRIs from the end of the second dwell time interval 906B to the end.

The second plot versus time in FIG. 9 shows the PRI count in each dwell time interval. The count restarts for each dwell time interval. The top plot versus time in FIG. 9 shows a realistic sequence of received reflected light pulses at pixel N. In realistic cases, not all emitted pulses necessarily produce reflected pulses that are detected at pixel N.

The third plot versus time in FIG. 9 shows an UP-DOWN CNT (count) 914. The UP-DOWN CNT 914 records an initially increasing count of the number of light pulses detected at pixel N as they are actually detected. A detected light pulse may be a desired reflected light pulse or a background/noise light pulse. The increasing count starts at the beginning of the first dwell time interval 906A and continues through the first half of the second dwell time interval 906B to end at the expected on-center time 908. As a detection of a light pulse by pixel N may not occur in some PRIs, the count may remain constant over multiple PRIs, as indicated by the larger duration of the interval during which the count has value 4.

Subsequent to expected on-center time 908, the value in the UP-DOWN CNT 914 decreases by one for each light pulse detected at pixel N. In some embodiments, the duration of the decreasing count time period may equal the duration of the increasing count time period. In the example shown, this is 1.5 times the number of PRIs in a dwell time interval. It should be noted that separate counts of the number of pulses detected at pixel N could be maintained in separate memory location for the number of light pulses detected before the on-center time 908 and for the number of light pulses detected during the decreasing count time period. There is thus a first time period (the Early time period) preceding the expected on-center time during which a first number, E, of detected light pulses detected at pixel N is counted, and a second time period (the Late time period) following the expected on-center time during which a second number, L, of reflected pulses detected at pixel N is counted. When the Early and Late time periods span a large number of PRIs, it may be more likely that a statistically significant number of the detected light pulses recorded by E and L are from reflected light pulses.

A statistically large difference between the first number E and the second number L (or their difference E−L) indicates the expected on-center time was not initially correct. For example, a larger second count number L indicates more reflected light pulses were detected during the Late time period. It can be inferred from this that the shifting wave of pulses was impinging more on pixel N−1 during the Early time period, and only shifted more onto pixel N during the Late time period.

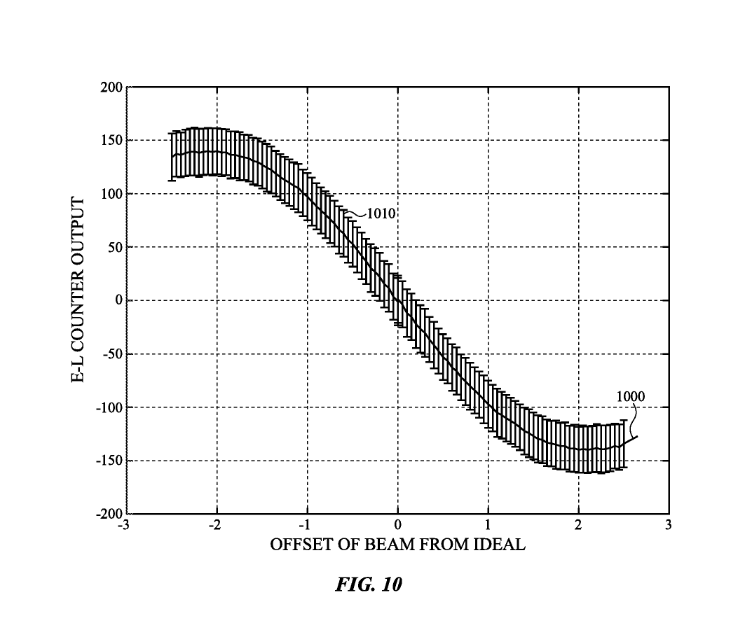

FIG. 10 shows a plot 1000 of the differences between the counts during the Early and Late time period counts (i.e., the value of E−L) as a function of offset of the beam from being correctly centered at a light sensing pixel at the expected on-center time. The horizontal axis represents arbitrary units depending on the offset quantity. In the shown experimental measurement, the offset measures an angle (in thousandths of radians) of the beam from being directly centered on the measuring pixel. Due to imperfections in measurement, the plot 1000 is shown with standard deviation error bars 1010.

A statistically large difference between the first number E and the second number L can then be used as an indicator to adjust operation(s) of the light emitting depth sensor as a whole. Adjustments include adjusting the direction or orientation of emission of the light pulses or changing a focusing mechanism so that the reflected pulses sweep across an activated pixel symmetrically about the expected on-center time. Other adjustments that may be used include altering the expected on-center times for other pixels or altering the start times or durations of the Early or Late time periods. Still other adjustments may be made.

One way to adjust an operation is to use the measured E−L value as a feedback to update the expected on-center times of the beam provided for the pixels. This is equivalent to updating the expected location of the beam on the array versus time of a sweep. In other embodiments, the adjustment can use updating the selection at the start of the Early and Late time periods used for each pixel.

There are some situations in which the use of the E and L values (or their difference) to adjust operation of the light emitting depth sensor may not be advantageous. The histogram of TOF values for a pixel may imply that an object is either very close or very far from the emitter. In the former case there can be large statistical variations in the number of received reflected light pulses due to the light pulses arriving while the light sensing pixel (such a SPAD pixel) recharges. In the latter case, there may be so few received reflected light pulses in each of the Early and Late time periods that differences between them may not be statistically valid. So adjustments to the operation of the light emitting depth sensor may only be applied when a determined distance is beyond a first threshold distance and within a second threshold distance.

Because the E and L values can be counted serially for each pixel in a sweep of the beam, a detected offset for one pixel can be used as feedback to adjust, for example, the expected on-center time provided to another pixel that is later in the sweep. The adjustment may also include changing the duration or start time of the Early or Late time periods, changing the focusing of the reflected light onto the array, or other operations.

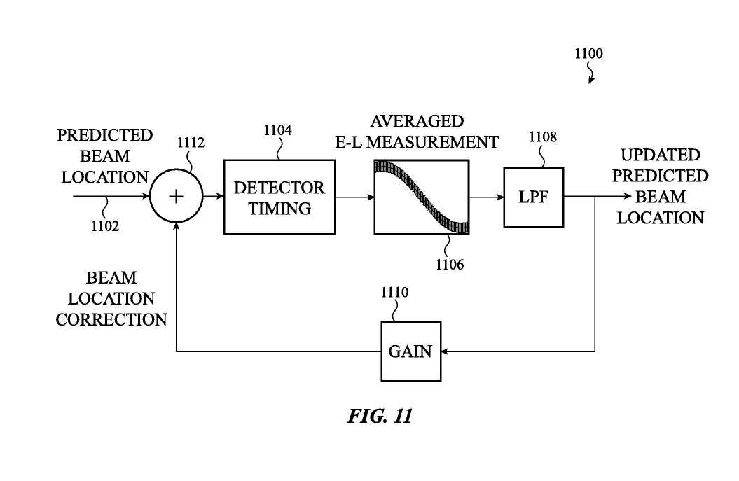

FIG. 11 shows a feedback loop 1100 that can be used to provide dynamically updated estimates of the beam's location and/or expected on-center times at other pixels.

An initial predicted beam location (equivalently, the expected on-center time) for a first pixel is obtained. In the block 1104, the E−L difference is determined. In some embodiments the E−L measurement is obtained for multiple pixels and averaged 1106. The E−L averaged values can then be passed through a low-pass filter 1108 for smoothing to remove noise. The output of the low-pass filter is then multiplied by a gain 1110, and provided as closed loop feedback 1112 to the input predictions. After initial settling, the updated predicted beam locations will more accurately track the actual beam locations during a sweep.

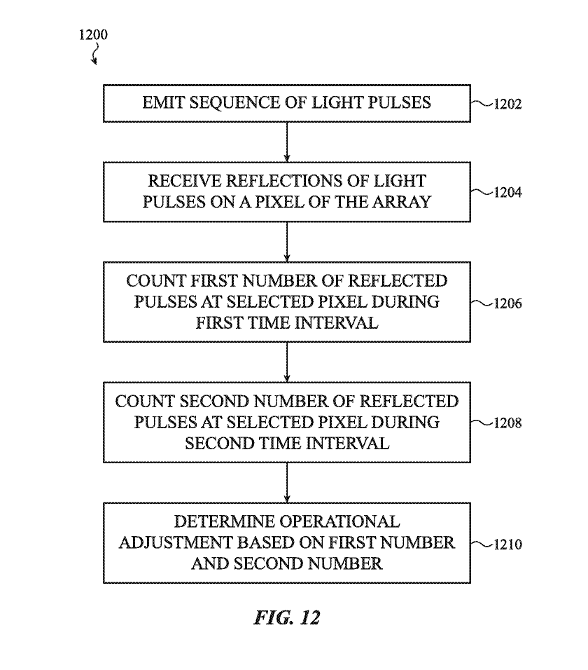

FIG. 12 is a flowchart for a method 1200 that can be used by a light emitting depth sensor to detect and range one or more objects in a field of view. The light emitting depth sensor can include a light emitter, such as an emitter of pulsed laser light, and an array of light sensing pixels. Other components may include a control mechanism for emitting the light, and another control mechanism for directing reflected light pulses from objects in the field of view onto the array.

At stage 1202 a sequence of light pulses is emitted into the field of view by the light emitter. The emission may follow a line scan pattern, and may consist of laser pulses separated by a pulse repetition interval.

At stage 1204 reflections of light pulses from a portion of the object are received at a pixel of the array of light sensing pixels. The pixel can be activated by the light emitting depth sensor so that at an expected on-center time, the numbers of reflected light pulses received at the pixel before and after the expected on-center time are approximately equal. At the expected on-center time the received reflected light pulses may have a maximum of intensity.

At stage 1206, during a first time period preceding the expected on-center time, a first number of received reflected pulses at the pixel is counted. The first number may include background pulses generated by light pulses other than reflections of the emitted light pulses. Alternatively, the first number may be the number of detected light pulses after removal of a measured background level of pulses.

At stage 1208, during a second time period following the expected on-center time, a second number of received reflected pulses at the pixel is counted. The second number may include background pulses generated by other than reflections of the emitted pulses, or may be the number of pulses after removal of a measured background level of pulses.

At stage 1210, based on the first number and the second number, or a difference between the first number and the second number, an adjustment may be made to the operation of the light emitting depth sensor.

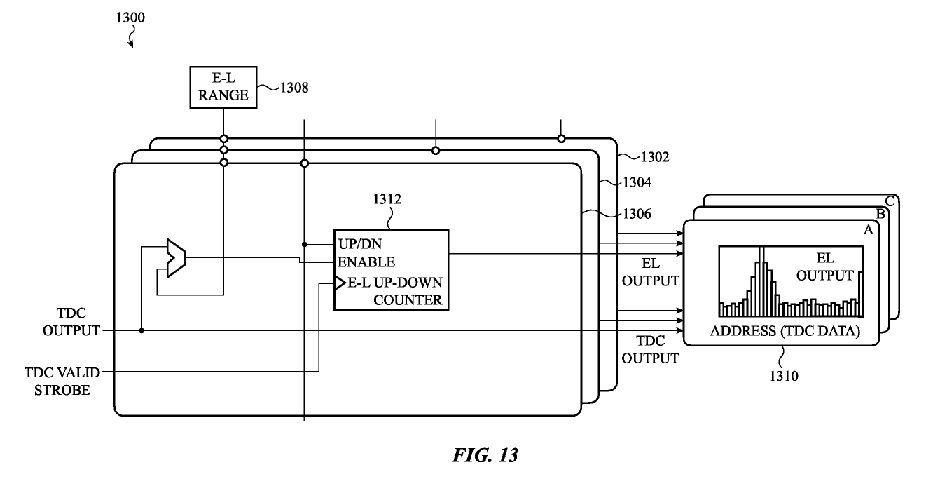

FIG. 13 shows a block diagram of exemplary circuit 1300 that can be used with the methods and devices described above. Three light sensing pixels—1302, 1304, and 1306—may be from the same column but adjacent rows, as described above, for overlap of processing. The three light sensing pixels can receive a controllable Early/Late counting range value 1308. An E−L up-down counter 1312 for each light sensing pixel is triggered by external signals to control the direction of the counting and whether to register a count in the histogram of that light sensing pixel. At the end of the counting time period, histograms 1310 for the three light sensing pixels can be used to determine a TOF. For memory efficiency, the histogram of each light sensing pixel may be expanded by one memory bin that can be used to store the E−L difference.

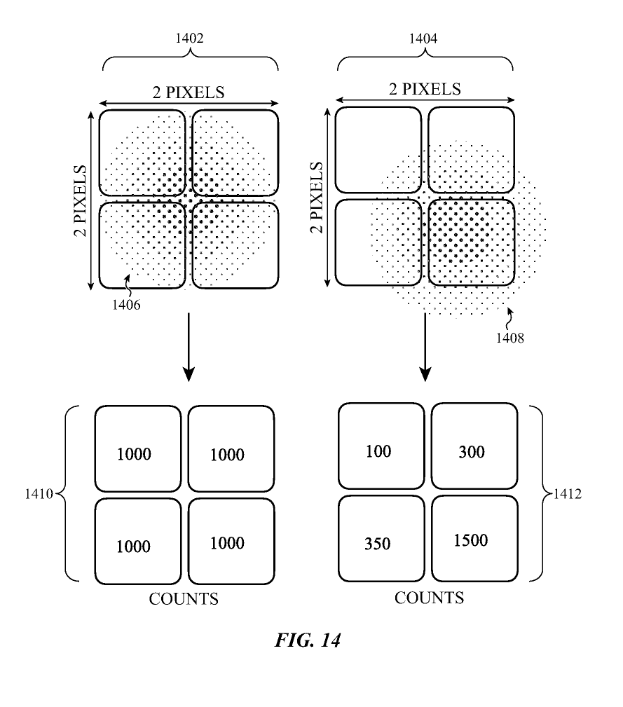

FIG. 14 illustrates another set of embodiments for how an array of light sensing pixels in a light detector can be used to detect offsets in an expected location of reflected light pulses in a light emitting depth sensor. Examples of systems that can implement the embodiments include line-scan systems, such as a LIDAR system, as well as systems with multiple emitters that emit light pulses in fixed directions. FIG. 14 illustrates embodiments that use a 2×2 subarray of light sensing pixels to detect offsets. Such a 2×2 subarray may be part of a full array of light sensing pixels within a light emitting depth sensor. It would be clear to one of skill in the art that the methods and systems described here can be applied to subarrays of other sizes, such as 3×3, 4×4, or to subarrays with different row and column sizes.

A 2×2 subarray is shown in an ideal case 1402 of beam reception, and shown in a non-ideal case 1404. The 2×2 subarray may be a subarray dedicated to detecting offsets of the reflected light beam. For example, the 2×2 subarray could be located on an edge of the full array where reflected beams in a line-scan system begin a traversal across a column (or row) of the full array. This could allow for correction of any detected offset of the reflected light beam before the reflected light beam traverses the full array. Additionally and/or alternatively, the 2×2 subarray can be dynamically selected from the full array as the reflected light beam moves across the full array so as to provide continual adjustments to the operation of a light emitting depth sensor system.

In the ideal case 1402, at an expected time the beam of reflected pulses 1406 is directed to strike the center of the 2×2 subarray. In the case of a 3×3 subarray, in an ideal case at the expected time the beam of reflected pulses could be directed to strike the central light sensing pixel. Over a counting time interval, comprising multiple PRIs, the respective number of reflected light pulses detected by each of the light sensing pixels is counted. In the ideal case, since the beam of reflected light pulses is correctly located at the center of the array, the numbers of detected reflected light pulses 1410 should be nearly equal, with deviations from exact equality within expected statistical variation.

In the non-ideal case 1404, at the expected time at which the beam is expected at the center of the array, the beam of reflected pulses 1408 is actually directed to a location shifted from the center of the array. As a result, the light sensing pixels' counted numbers of detected reflected light pulses 1412 deviate from equality more than can be accounted for by statistical variation. In consequence the offset of the beam can be determined, and adjustments made. The adjustments include, but are not limited to, modifying the direction of the emitted light beams, altering a focus control mechanism for a lens, such as lens 416, or adjusting a timing of the counting time periods about each light sensing pixel.

In some embodiments, such as those that use multiple emitted light beams, multiple different subarrays of pixels may be activated for each received beam. For example, in some embodiments, a plurality of M×N active subarrays may be selected from the full array during sensing, with the active subarrays separated by subarrays of sizes Y×N and M×X having inactive pixels. If the expected distributions of numbers of received light pulses in the light sensing pixels of the active subarrays have detected deviations from the expected, adjustments to the light sensing depth sensor as a whole can be made. Additionally and/or alternatively, the locations of the selected active subarrays within the full array can be adjusted by control circuitry so that active subarrays better align with the received beams.

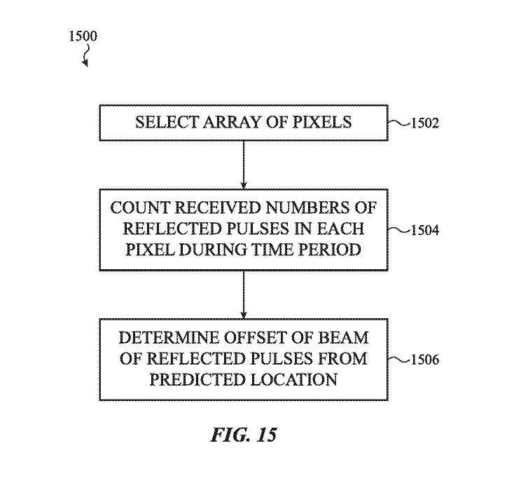

FIG. 15 is a flowchart of a method 1500 for determining an offset of a beam of reflected light pulses arriving on a full array of light sensing pixels, such as pixels based on SPADs, or those based on other technologies.

At stage 1502 of the method, a subarray (or a plurality thereof) of light sensing pixels is selected from among the light sensing pixels of the full array. As described above, the selected subarray of light sensing pixels may be a dedicated subarray for determining an offset of the beam of reflected light pulses, or may be selected dynamically.

At stage 1504, during a counting time period, the number of light pulses detected in each pixel is counted. In some embodiments, the counting may weight some detected light pulses as providing a larger count than other detected light pulses. Some embodiments may subtract the background quantity of detected light pulses so that each pixel's count more accurately estimates the number of reflected light pulses received.

At stage 1506, the counts obtained during the counting time period are compared to determine if there is an offset in the location of the beam of reflected pulses. If no offset is determined, then no corrections need to be applied. But when an offset is found, a correction of compensation can be applied. For example, alterations to the direction at which the emitter sends out the pulses can be made, or changes to the receiving system can be made.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method of operating a light emitting depth sensor, comprising:
emitting a sequence of emitted light pulses into a field of view;
determining a first number of detected light pulses detected at a light sensing pixel of an array of light sensing pixels during a first time period;
determining a second number of detected light pulses detected at the light sensing pixel during a second time period subsequent to the first time period; and
adjusting operation of the light emitting depth sensor based on the first number and the second number;
wherein:
the detected light pulses detected at the light sensing pixel during at least one of the first time period and the second time period include a plurality of reflections of the sequence of emitted light pulses from an object in the field of view.

2. The method of claim 1, wherein a first duration of the first time period and a second duration of the second time period are each a fixed multiple of a pulse repetition interval of the sequence of emitted light pulses.

3. The method of claim 2, wherein adjusting operation of the light emitting depth sensor comprises altering an expected on-center time of the reflections of the sequence of emitted light pulses at the light sensing pixel.

4. The method of claim 1, further comprising:
forming a histogram of time of flight values of the light pulses detected during both the first time period and the second time period; and
estimating a distance to a portion of the object based on the histogram.

5. The method of claim 4, further comprising weighting a first time of flight value corresponding to a first detected light pulse in the histogram based on a proximity of a first time of detection of the first detected light pulse to an expected on-center time at the light sensing pixel.

6. The method of claim 4, further comprising determining that the distance is above a first threshold and below a second threshold,
wherein the adjusting operation of the light emitting depth sensor is performed when the estimated distance is above the first threshold and below the second threshold.

7. The method of claim 1, further comprising activating the light sensing pixel for detection of the first number of the light pulses and the second number of the light pulses during a time interval containing an expected on-center time of the reflections of the sequence of emitted light pulses at the activated light sensing pixel.

8. The method of claim 1, further comprising estimating distortions in how the reflections of the sequence of emitted light pulses are received at the array.

9. The method of claim 1, wherein:
the light sensing pixel is a first light sensing pixel;
the array of light sensing pixels comprises a second light sensing pixel adjacent to the first light sensing pixel; and
the emitted sequence of light pulses is emitted into the field of view to cause the reflections of the sequence of emitted light pulses to be received at the first light sensing pixel and subsequently at the second light sensing pixel.

10. The method of claim 9, further comprising:
determining a third number of the detected light pulses detected at the second light sensing pixel during a third time period; and
determining a fourth number of the reflected light pulses that are received at the second light sensing pixel during a fourth time period following the third time period;
wherein adjusting operation of the light emitting depth sensor is further based on the third number and the fourth number.

11. The method of claim 1, wherein adjusting operation the light emitting depth sensor comprises adjusting at least one of a first duration of the first time period or a second duration of the second time period.

12. The method of claim 1, wherein adjusting operation of the light emitting depth sensor comprises adjusting one of altering a direction at which a light source emits the sequence of emitted light pulses and altering how the reflections of the sequence of emitted light pulses are directed onto the array.

13. An electronic device comprising:
an electronic timing control system;
at least one light emitter operably associated with the electronic timing control system; and
an array of light sensing pixels operably associated with the electronic timing control system;
wherein the electronic timing control system is configured to:
provide a first set of timing control signals that cause the at least one light emitter to emit a sequence of light pulses into a field of view;
activate a light sensing pixel of the array of light sensing pixels to detect light pulses;
provide a second set of timing control signals that cause:
a counter to count a first number of light pulses detected by the light sensing pixel during a first time period preceding an expected arrival time of reflections of the emitted sequence of light pulses at the activated light sensing pixel; and
the counter to count a second number of light pulses detected by the light sensing pixel during a second time period following the expected arrival time;
and
adjust operation of the electronic device based on the first number and the second number.

14. The electronic device of claim 13, wherein the emitted sequence of light pulses is emitted into the field of view according to a line scan pattern, and a set of the reflections of the emitted sequence of light pulses are directed across a row of the array of light sensing pixels.

15. The electronic device of claim 13, wherein adjustment of the operation of the electronic device includes applying a correction to the expected arrival time at the activated light sensing pixel.

16. The electronic device of claim 15, wherein the correction is determined using a feedback loop.

17. The electronic device of claim 13, wherein the electronic timing control system further is configured to:
form a histogram of time of flight values based on both the detected light pulses detected during the first time period and the detected light pulses detected during the second time period; and
determine a distance to a portion of an object in the field of view based on the histogram.

18. The electronic device of claim 13, wherein adjusting operation of the electronic device comprises adjusting at least one of a first duration of the first time period or a second duration of the second time period.

19. The electronic device of claim 13, wherein at least one light sensing pixel of the array of light sensing pixels includes a single photon avalanche diode.

20. A method of operating a light emitting depth sensor, comprising:
emitting a sequence of light pulses into a field of view during a counting time period;
receiving, at a subarray of light sensing pixels of an array light sensing pixels, reflected light pulses corresponding to reflections of a subset of the emitted light pulses from an object in the field of view;
for each of the light sensing pixels in the subarray, counting respective numbers of detected light pulses that are received during the counting time period, the detected light pulses including the reflected light pulses; and
adjusting operation of the light emitting depth sensor based on the respective numbers of detected light pulses.

21. The method of claim 20, wherein adjusting operation of the light emitting depth sensor includes adjusting at least one of: an emission of the sequence of light pulses into the field of view, or a directing of the reflected light pulses onto the subarray of light sensing pixels.
